(19) United States
(12) Patent Application Publication
(10) Pub. No.: US 2011/0285517 A1
(43) Pub. Date: Nov. 24, 2011

(54) TERMINAL APPARATUS AND VIBRATION NOTIFICATION METHOD THEREOF

(76) Inventor: Tai-Seng LAM, Taipei City (TW)

(21) Appl. No.: 12/782,367

(22) Filed: May 18, 2010

(51) Int. Cl. G08B 6/00

(52) U.S. Cl. 340/407.2

(57) ABSTRACT

The present invention is related to a terminal apparatus and a vibration notification method thereof. The terminal apparatus comprises: a touch screen panel for inputting a contact point by users and generating a touch control signal in response to the contact point; a detecting unit coupled to the touch screen panel for sensing the touch control signal and generating a control signal and a touch-control coordinating signal with respect to the touch control signal; a vibrating unit coupled to the detecting unit for generating a vibration notification in response to the control signal; a microprocessor unit coupled to the detecting unit for displaying the touch-control signal on a display unit with respect to the touch-control coordinating signal. Whereby, the users are capable of being notified by vibrating movements of the touch screen panel as the touch control signal is inputted, thereby confirming the touch control signal has been processed successfully.

### BACKGROUND OF THE INVENTION

1. Field of the Invention

The present invention relates to a terminal apparatus, and more particularly, to a terminal apparatus having a vibration notification function activated by touch.

2. Description of Related Art

With the continuous development of interface technology, the interaction between man kind and machines advances toward to be more accurate and convenience. In particular, the touch screen panel technology applied in a variety of different application fields and environments facilitates users to be able to input and control machines easily and conveniently. Touch screen panels are the most convenience communication interface between man and machines recently. Users utilize fingers or touch pens, etc., for scrolling, selecting, hand-writing, or inputting different finger gestures intuitively to enable the touch screen panel to generate a touch control signal. And the touch screen panel acquires a coordinate value of the touch control signal detected and computed by the internal circuitry thereof. The coordinate value is inputted to the machines, thereby achieving the objective of controlling the machines.

These machines, in particular to some kinds of terminal apparatuses, e.g., automated teller machines of banks, point on sale devices of stores, or various computer equipments and handheld devices, all apply the touch screen panels as input interfaces thereof so as to enhance for convenience of inputting process.

Therefore, the touch screen panels merely receive input signals from users passively, but not provide appropriate notification signals to feedback and notify the users that the inputted touch control signals from users have been detected by the touch screen panels. To be more specific, the terminal apparatuses can not feedback notification signals to inform that whether the input signals have been received by the terminal apparatuses as the users touch the touch screen panels. Thus, when the users are performing operations on the touch screen panels, it may often click and select objects more than once, thereby resulting in duplicated inputting and troubling the users.

Though the conventional terminal apparatuses have made improvements correspondingly, such as, by utilizing a sound notification or a graphic notification, to alert the users that the input signals have been detected by the touch screen panels while the users perform inputting on the touch screen panels. However, the above-mentioned methods are not the most straight forward prompt methods. The users are still required to make judgments by means of the sense of visual or the sense of hearing, but not make judgments thru the sense of touch. In some specific circumstances, e.g. noisy environments or environments with strong illumination intensities, it may cause difficulties to determine by merely sound or graphic identification, thereby resulting in issues for the users in applications.

### SUMMARY OF THE INVENTION

The above deficiencies and problems associated with terminal apparatuses and touch screen panels are eliminated by the disclosed multifunction device. In the embodiment according to the present invention, a terminal apparatus is provided which comprises: a touch screen panel, for inputting a touch control signal; a detecting unit, coupled to the touch screen panel, for generating a control signal in response to the touch control signal; and a vibrating unit, coupled to the detecting unit, for generating a vibration notification in response to the control signal.

In view of the aforementioned issues, a terminal apparatus is provided to solve the issues, which comprises: a touch screen panel, for inputting a touch control signal; a detecting unit, coupled to the touch screen panel, for generating a touch-control coordinating signal in response to the touch control signal; a microprocessor unit, coupled to the detecting unit, for generating a control signal in response to the touch control signal; and a vibrating unit, coupled to the microprocessor unit, for generating a vibration notification in response to the control signal.

According to the embodiment of the present invention, a vibration notification method of a terminal apparatus is disclosed. The steps of the vibration notification method comprises: inputting a touch control signal by a touch screen panel; receiving the touch control signal by a detecting unit so as to generate a control signal; and driving a vibrating unit in response to the control signal so as to generate a vibration notification and transmit it to the touch screen panel.

To solve the aforementioned issues, a vibration notification method of a terminal apparatus in accordance with certain aspects of the present invention is disclosed. The steps of the vibration notification method comprises: inputting a touch control signal by a touch screen panel; receiving the touch control signal by a detecting unit so as to generate a touch-control coordinating signal; and generating a control signal by a microprocessor unit as the touch-control coordinating signal matches to information regarding coordinate definition stored in a memory unit. The control signal is used to trigger a vibration unit so as to generate vibrating movements by the vibrating unit and transmit a vibration notification to the touch screen panel.

The technical proposals and concepts of the terminal apparatus having vibration notification function triggering by touch in accordance with certain aspects of present invention are not familiar by the ones skilled in the art, thereby promoting industrial upgrading.

In order to further understand the techniques, means and effects the present invention, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention.

### BRIEF DESCRIPTION OF THE DRAWINGS

FIG. 1 illustrates a schematic diagram of an embodiment of a terminal apparatus with a vibration notification function activated by touch according to the present invention;

FIG. 2 illustrates a module schematic diagram of a first embodiment of the terminal apparatus with the vibration notification function activated by touch according to the present invention;

FIG. 3 illustrates a flowchart of the first embodiment of the terminal apparatus with the vibration notification function activated by touch according to the present invention;

FIG. 4 illustrates a module schematic diagram of a second embodiment of the terminal apparatus with the vibration notification function activated by touch according to the present invention; and

FIG. 5 illustrates a flowchart of the second embodiment of the terminal apparatus with the vibration notification function activated by touch according to the present invention.

### DETAILED DESCRIPTION OF THE PREFERRED EMBODIMENTS

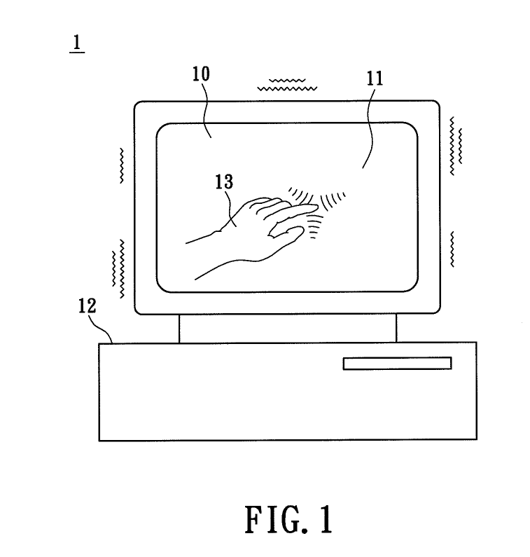

Please refer to FIG. 1, in which a schematic diagram of an embodiment of a terminal apparatus with a vibration notification function activated by touch according to the present invention is demonstrated.

A terminal apparatus 1, which comprises a display unit 10 and a host system 12. A touch screen panel 11 is on the outer surface of the display unit 10. The touch screen panel 11 is provided for a user 13 to input a contact point and generate a touch control signal accordingly. Whereby, the user may utilize the touch control signal inputted to perform operations and control the terminal apparatus 1.

When the user 13 touches the touch screen panel 11 for inputting a touch control signal, the terminal apparatus 1 may generate a vibration notification in response to the touch control signal inputted by the user 13. And the vibration notification may be transmitted to the touch screen panel 11. The user 13 may receive the vibration notification and feel the vibrating movements of the touch screen panel 11 while the touch control signal is inputting simultaneously, such that the user 13 is prompted that the touch control signal has been received by the touch screen panel 11. In accordance with the method, the user 13 may determine whether the touch control signal has been received by the terminal apparatus 1 by means of touching sense directly.

In particular for utilizing the method under some specific circumstances, e.g., in a noisy environment or in an environment with strong illumination intensity, it may clearly identify and determine whether the touch control signal has been detected and received by the terminal apparatus 1. Thus, handheld devices or point on sale (POS) devices applied in outdoor areas may be supported and prompted by a vibrating touch feeling in accordance with the technical features of the present invention. Consequently, the user 13 is not restricted by the sound or graphic notification systems according to the prior art. The user 13 may determine the input of the touch control signal by sensing the vibrating touch feeling directly, thereby preventing situations, such as, incorrect operations or duplicated inputs, occurred.

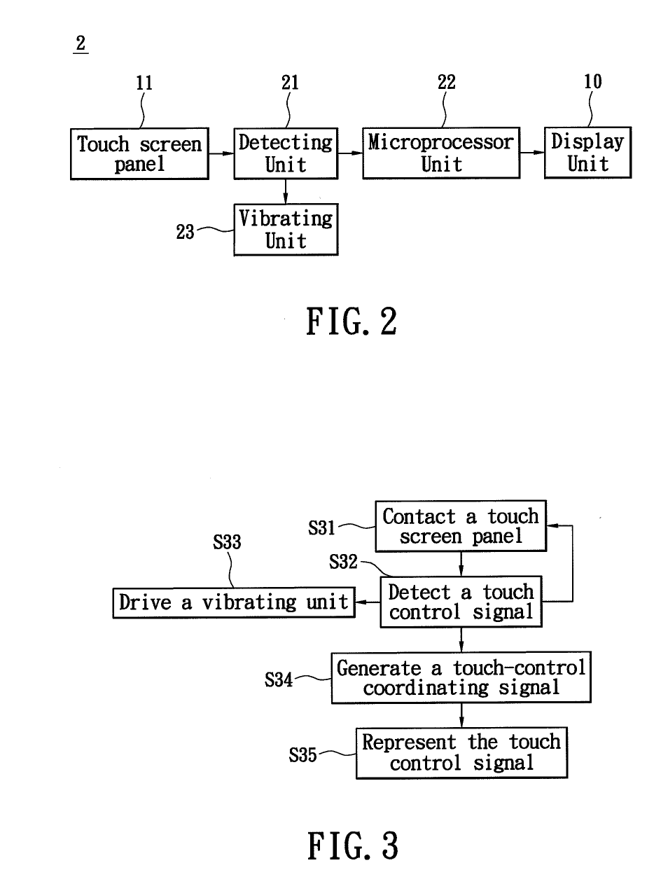

Next, please refer to FIG. 2, in which a module schematic diagram of a first embodiment of the terminal apparatus with the vibration notification function activated by touch according to the present invention is demonstrated.

A terminal apparatus 2, comprises a touch screen panel 11, for inputting a touch control signal, a detecting unit 21, coupled to the touch screen panel 11, for receiving the touch control signal and generating a touch-control coordinating signal in response to the touch control signal; a microprocessor unit 22, coupled to the detecting unit 21, for receiving the touch-control coordinating signal, thereby either displaying it on a display unit 10 directly, or implementing a program software and displaying the touch-control coordinating signal on the display unit 10; and a vibrating unit 23, coupled to the detecting unit 21, for performing operations to generate a vibration notification with respect to a control signal of the detecting unit. Wherein, the touch screen panel 11 is configured on the outer surface of the display unit 10. The ones ordinary skilled in the art are apparent to integrate the touch screen panel 11 to the display unit 10. The vibrating unit 23 may be of a vibration motor which is disposed nearby the touch screen panel 11 and the display unit 10, so that the vibrating movements of the vibration motor may transmit to the outer surface of the touch screen panel 11. Hence, a plurality of vibration motors with different vibrating frequencies is installed, so as to generate different vibrating frequencies simultaneously or apply accumulations of the plurality of different vibrating frequencies, for generating a specific vibration notification.

When the user 13 touches the touch screen pane 11, the touch screen panel 11 may generate a touch control signal in accordance with the contact point touched by the users 13 on the touch screen panel 11. The detecting unit 21 receives the touch control signal and generates a touch-control coordinating signal accordingly. The touch-control coordinating signal and the contact point are in a corresponding relationship. The microprocessor unit 22 represents the touch-control coordinating signal on the display unit 10. Moreover, when the detecting unit 21 receives the touch control signal, it may generate a control signal and the touch-control coordinating signal simultaneously. The vibrating unit 23 receives the control signal and produces a vibration notification having a default time and a default frequency with respect to the control signal.

Therefore, when the user 13 contacts the touch screen panel 11 and inputs a touch control signal, the vibrating unit 23 may activate the vibrating notification in the default time and in the default frequency. The vibration notification may transmit to the outer surface of the touch screen panel 11. The user 13 may then receive and feel the vibration notification so as to get that the inputted touch control signal has been detected and then received by the terminal apparatus 2.

Please refer to FIG. 3 in conjunction with FIG. 2, in which a flowchart of the first embodiment of the terminal apparatus with the vibration notification function activated by touch according to the present invention is demonstrated.

While the user 13 contacts the touch screen panel 11, the touch screen panel 11 may generate a touch control signal as shown in step S31. The detecting unit 21 may detect the touch screen panel 11 periodically. When the detecting unit 21 detects the touch control signal inputted by the user 13, a touch-control coordinating signal may be generated with respect to the touch control signal as shown in steps S32 and S34. Meanwhile, the detecting unit 21 generates a control signal in response to the touch control signal and transmits the control signal to the vibrating unit 23. Subsequently, the vibrating unit 23 generates a vibration notification having a default time and a default frequency with respect to the control signal in step S33. Meanwhile, the vibration notification produced by the vibrating unit 23 may transmit to the touch screen panel 11. As the user 13 contacts the touch screen panel 11 to input the touch control signal, the user 13 may receive and feel the vibrating movements. To be more specific, as the user 13 contacts the touch screen panel 11, meanwhile, the terminal apparatus 2 may generate a feedback of a vibrating signal, so that the user 13 may be prompted that the touch control signal inputted has been received by the terminal apparatus 2 by means of receiving the vibration notification. Next, the microprocessor unit 22 receives the touch-control coordinating signal generated by the detecting unit 21, and represents the touch-control coordinating signal corresponding to the contact point on the display unit 10 in step S35.

By means of the vibrating notification method, as the user 13 utilizes the touch screen panel 11 to input the touch control signal or control the operations of the terminal apparatus 2, it may feel a touch feeling of vibrating movements, i.e. the vibration notification generated by the vibrating unit 23. Whereby, the user 13 may input the touch control signal accurately so as to perform operations and controls of the terminal apparatus 2 without worrying about that the touch control signal which is intended to be inputted has not been detected by the terminal apparatus 2, thereby producing duplicate inputs or causing input errors.

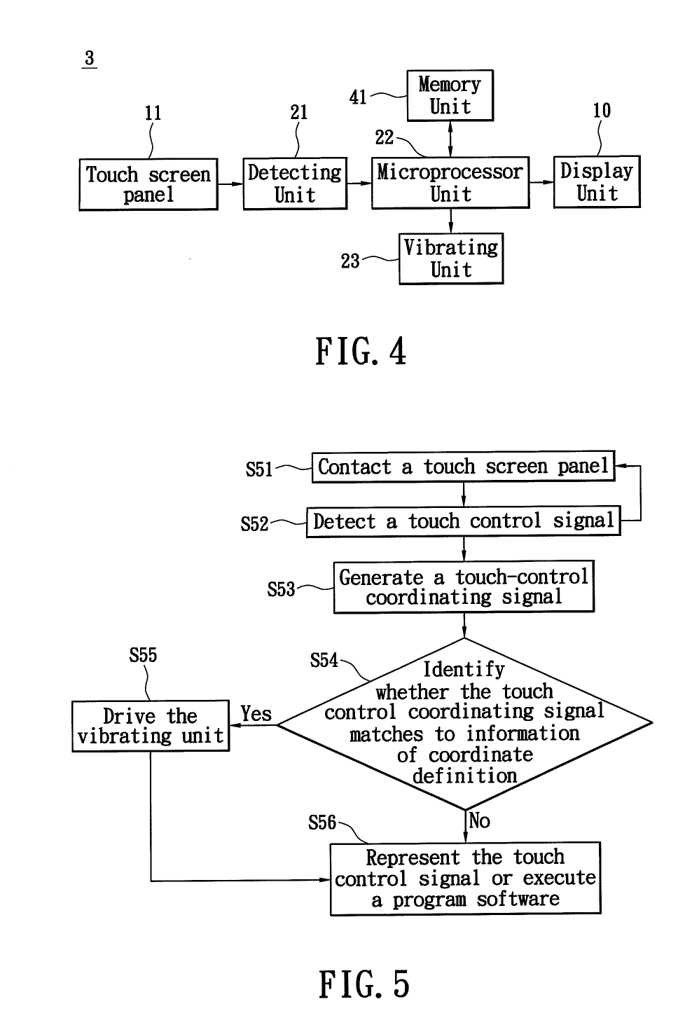

Please refer to FIG. 4, in which a module schematic diagram of a second embodiment of the terminal apparatus with the vibration notification function activated by touch according to the present invention is demonstrated.

A terminal apparatus 3 has a module configuration similar to that of the first embodiment. The vibrating unit 23 and a memory unit 42 are coupled to the microprocessor unit 22, wherein the vibrating unit 23 generates the vibration notification in response to the control signal produced by the microprocessor unit 22. The memory unit 41 stores information regarding coordinate definition or a program software. The touch screen panel 11 is configured on the outer surface of the display unit 10. The ones skilled in the art may integrate the touch screen panel 11 to the display unit 10. The vibrating unit 23 is disposed nearby the touch screen panel 11 and the display unit 10 so as to allow the vibrating movements of the vibrating unit 23 transmitting to the outer surface of the touch screen panel 11.

When the user 13 inputs a touch control signal and contacts the touch screen panel 11, the touch screen panel 11 produces a touch control signal corresponding to the contact point touched by the user 13. The detecting unit 21 generates a touch-control coordinating signal in response to the control signal. The microprocessor unit 22 receives the touch-control coordinating signal and generates a control signal accordingly to control the vibrating unit 23 to produce a vibration notification with a default frequency under a default time. The vibration notification may be transmitted to the whole terminal apparatus 3, such that the terminal apparatus 3 vibrates with respect to the vibration notification received. Furthermore, the user 13 may sense a vibrating feeling as the user 13 touches the outer surface of the touch screen panel 11 and feels the vibrating movements. The vibrating feeling is corresponding to the touch control signal inputted. Therefore, the user 13 may be immediately prompted that the touch control signal inputted has been detected by the terminal apparatus 3. At the same time, the microprocessor 22 represents the touch control coordinating signal corresponding with the contact point touched by the user 13 on the display unit 10.

The terminal apparatus 3 usually display different icons or pressed buttons on specific positions of the display unit 10 regarding requirements of the program software or other customized specifications, e.g., the point on sale device often represent specific buttons on specific locations accordingly to facilitate convenience of use. The present invention may generate different vibration frequencies or different vibration time in accordance with different location coordinates which have different icons or different pressed buttons. It may not generate any vibration notifications as no any icons or pressed buttons are selected.

In the aspects of the aforementioned descriptions, when the microprocessor unit 22 receives the touch-control coordinating signal, it may compare the touch-control coordinating signal to the information regarding coordinate definition stored in the memory unit 42. While the touch-control coordinating signal matches to the information regarding coordinate definition, the corresponding control signal may be generated so as to control the vibrating unit 23 to produce a vibration notification under a certain vibration frequency or a certain vibration time; while the touch-control coordinating signal does not match to the information regarding coordinate definition, the microprocessor 22 may not generate the control signal or may control the vibrating unit 23 to output a vibration notification indicating errors. In other words, the terminal apparatus 3 may not vibrate or may produce the vibration notification concerning inputting errors, such that the user 13 may be promoted that correct icons or pressed buttons are not selected. Herein, the vibration notification concerning error inputs has different vibration frequencies and periods with respect to the other vibration notifications

Additionally, the terminal apparatus 3 may provide the vibration notification based on whether the built-in program software is implemented. While the microprocessor unit 22 received the touch-control coordinating signal, and meanwhile, the microprocessor 22 executes the program software stored in the memory unit 41 in response to the touch control coordinating signal, a corresponding control signal may be generated, so that the vibrating unit 23 is controlled to function under a specific vibration frequency and a specific vibration time; while the microprocessor 22 does not execute the program software stored in the memory unit 42 in response to the touch-control coordination signal, the control signal is not generated, such that the terminal apparatus 2 may not vibrate. Consequently, the user 13 may immediately be prompted that whether the terminal apparatus 3 executes the program software which is intended to be opened by means of feeling the vibration movements, i.e., the vibration notification.

Please refer to FIG. 5 in conjunction with FIG. 4, in which a flowchart of the second embodiment of the terminal apparatus with the vibration notification function activated by touch according to the present invention is demonstrated.

As the user 13 contacts the touch screen panel 11, the touch screen panel 11 may produce a touch control signal as shown in step S51. The detecting unit 21 may detect the touch screen panel 11 periodically. When the detecting unit 21 identifies the touch control signal, a touch-control coordinating signal may be produced in steps S52 and S53. The microprocessor unit 22 may determine with respect to either whether the touch-control coordinating signal matches to the information concerning coordinate definition stored in the memory unit 41 or whether the built-in program software of the memory unit 41 is executed by the touch-control coordinating signal in step S54. In other words, while the touch-control coordinating signal matches to the information regarding coordinate definition or the touch-control coordinating signal drives the microprocessor 22 to implement the program software, the microprocessor 22 may produce a control signal to control the vibrating unit 23 to vibrate, in step S55. Moreover, the microprocessor unit 22 controls the vibrating unit 23 to start vibrating, it may also control the display unit 10 to show touch-control coordinating signal or demonstrate the program software which has been opened and executed as shown in step S56. While the touch-control coordinating signal does not match to the information concerning coordinate definition, or the touch-control coordinating signal does not drive the microprocessor unit 22 to execute the program software, it may simply represent the touch-control coordinating signal on the display unit 10 without activating the vibrating unit 23 to vibrate, in step S56.

According to the vibration notification method, as the user 13 utilizes the touch screen panel 11 to input the touch control signal or control the operations of the terminal apparatus 3, it may feel a touch feeling of vibrating movements, i.e. the vibration notification generated by the vibrating unit 23, on the touch screen panel 11 in accordance with the touch-control coordinating signal selected by the user 13. Whereby, the user 13 may input the touch control signal accurately so as to perform operations and controls of the terminal apparatus 3 without worrying about that the input signal which is intended to be inputted has not been detected by the terminal apparatus 3, thereby producing duplicate inputs or causing input errors.

In the aspects of the aforementioned technical proposals, the notification effect of the vibrating unit 23 by means of vibrating may change to trigger the display unit 10, so that the microprocessor 22 may control the display unit 10 to generate a lighting point, or any one of particular graphic icons on the contact point inputted by the user 13 with respect to the touch-control coordinating signal. In addition, the vibration unit 23 may be changed to be a sound generating unit (not shown), such that as the user 12 contacts the touch screen panel 11, a sound notification may be generated and outputted.

In the aspects of the aforementioned embodiments according to the present invention, a notification method may implement in cooperation with the above-mentioned methods. When the user 13 contacts the touch screen panel 11, the vibrating unit 23 may generate vibrating movements, control the display unit 10 to produce a corresponding lighting point or graphic icon with respect to the contact point, and control the sound generating unit (not shown) to output a sound notification, etc. Consequently, the user 13 may feel by means of the sense of visual, the sense of hearing, and the sense of touch, thereby confirming the touch control signal which is intended to be inputted has been detected and received by the terminal apparatus 1.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A terminal apparatus, comprising:
a touch screen panel, for inputting a touch control signal;
a detecting unit, coupled to the touch screen panel, for generating a control signal in response to the touch control signal; and
a vibrating unit, coupled to the detecting unit, for generating a vibration notification in response to the control signal.

2. The terminal apparatus according to claim 1, further including a microprocessor unit and a display unit, wherein the microprocessor unit is connected with the detecting unit and the display unit.

3. The terminal apparatus according to claim 2, wherein the detecting unit generates a touch-control coordinating signal in response to the touch control signal, the microprocessor unit receives the touch-control coordinating signal and controls the display unit to demonstrate a coordinating signal corresponding with the touch-control coordinating signal.

4. The terminal apparatus according to claim 2, wherein the touch screen panel is configured on the outer surface of the display unit or is integrated inside the display unit.

5. The terminal apparatus according to claim 1, wherein the vibrating unit is disposed nearby the touch screen panel and the display unit so as to transmit the vibration notification to the outer surface of the touch screen panel, and the vibrating unit is a vibration motor.

6. A terminal apparatus, comprising:
a touch screen panel, for inputting a touch control signal;
a detecting unit, coupled to the touch screen panel, for generating a touch-control coordinating signal in response to the touch control signal;
a microprocessor unit, coupled to the detecting unit, for generating a control signal in response to the touch control signal; and
a vibrating unit, coupled to the microprocessor unit, for generating a vibration notification in response to the control signal.

7. The terminal apparatus according to claim 6, further including a display unit and a memory unit, wherein the microprocessor unit connects to the detecting unit, the display unit, and the memory unit which stores information regarding coordinate definition or a program software.

8. The terminal apparatus according to claim 7, wherein the detecting unit generates a touch-control coordinating signal in response to the touch control signal, the microprocessor unit receives the touch-control coordinating signal and controls the display unit to demonstrate a coordinating signal corresponding with the touch-control coordinating signal.

9. The terminal apparatus according to claim 7, wherein the microprocessor unit compares to information regarding coordinate definition with respect to the touch-control coordinating signal and when the touch control coordinating signal is matched to information regarding coordinate definition, the control signal is generated.

10. The terminal apparatus according to claim 7, wherein the microprocessor unit opens the program software in response to the touch-control coordinating signal for generating the control signal.

11. The terminal apparatus according to claim 7, wherein the touch screen panel is configured on the outer surface of the display unit or is integrated inside the display unit.

12. The terminal apparatus according to claim 7, wherein the vibrating unit is disposed nearby the touch screen panel and the display unit so as to transmit the vibration notification to the outer surface of the touch screen panel, and the vibrating unit is a vibration motor.

13. A vibration notification method of a terminal apparatus, comprising:
inputting a touch control signal by a touch screen panel;
receiving the touch control signal by a detecting unit so as to generate a control signal; and
driving a vibrating unit in response to the control signal so as to generate a vibration notification and transmit it to the touch screen panel.

14. The vibration notification method of the terminal apparatus according to claim 13, further including a microprocessor and a display unit, the detecting unit generates a touch-control coordinating signal in response to the touch control signal, the microprocessor unit receives the touch-control coordinating signal and controls the display unit to demonstrate a coordinating signal corresponding with the touch-control coordinating signal.

15. The vibration notification method of the terminal apparatus according to claim 14, wherein the touch screen panel is configured on the outer surface of the display unit or is integrated inside the display unit.

16. The vibration notification method of the terminal apparatus according to claim 14, wherein the vibrating unit is disposed nearby the touch screen panel and the display unit so as to transmit the vibration notification to the outer surface of the touch screen panel and the vibrating unit is a vibration motor.

17. The vibration notification method of the terminal apparatus according to claim 13, further including the steps of identifying the touch-control coordinating signal matched to information regarding coordinate definition stored in a memory unit by a microprocessor unit and generating a control signal to trigger a vibrating unit by means of the microprocessor unit.

18. The vibration notification method of the terminal apparatus according to claim 17, further including the steps of determining whether to activate a program software stored in the memory unit with respect to the touch-control coordinating signal and generating the control signal by means of the microprocessor unit.
